(19) United States
(12) Patent Application Publication
(10) Pub. No.: US 2005/0177516 A1
(43) Pub. Date: Aug. 11, 2005

(54) System and method of protecting digital content

(76) Inventors: Eric Vandewater, Scottsdale, AZ (US); Peter Jacobs, Phoenix, AZ (US)

Correspondence Address: KNOBLE YOSHIDA & DUNLEAVY, LLC;Eight Penn Center, Suite 1350, 1628 John F. Kennedy Blvd., Philadelphia, PA, 19103, US

(21) Appl. No.: 10/773,686

(22) Filed: Feb. 6, 2004

(51) Int. Cl. G06F 17/60

(52) U.S. Cl. 705/57; 705/52

(57) ABSTRACT

A method of operating a personal computer includes steps of determining whether a digital recordation of content that is readable by a hardware device in the personal computer is protected; and responsive to a determination that the digital recordation of content is protected, selectively limiting which software programs are permitted to access digital information from the digital recordation of content. Programs that are authorized to access the digital information may include a conversion program for converting the digital work to a compressed file format that will be stored on the hard drive of the personal computer in a format that is governed by a digital rights management protocol, secure player software that is enabled to play the digital work directly from the digital recordation of content and controlled copy software that permits copies to be made under specified licensing conditions.

### BACKGROUND OF THE INVENTION

1. Field of the Invention

This invention relates generally to the field of digital recordation and distribution of protected content of works such as audio compositions and video productions. More specifically, this invention relates to an improved system and method of protecting such digital content from unlawful copying and distribution by using a personal computer.

2. Description of the Related Technology

The widespread use of personal computers and Internet access has permitted extensive unauthorized digital extraction, reproduction and distribution of a significant amount of artistic content, including audio, video, software, images and text. Significant contributing factors to this unauthorized distribution include the large volume of digital content that has been made available to consumers in formats such as audio CD, CD-ROM, CD-R, DVD and DVD-R media and the ease of digital extraction and duplication of the music or other content on these physical media. Unfortunately, the standards used to produce the content for audio CDs (e.g., the IEC 60908 Redbook Standard) were not originally intended to prevent transfer of the content in digital or analog form and do not use methods to conceal the digital data on the CD for preventing unauthorized transfer. Further, copies made using digital processes are of high quality. Even copies using compressed formats such as, for example the standard MPEG Audio Layer 3 (MP3) format or Microsoft's Windows® Media (WMA) format, are of good quality in comparison to prior analog copying approaches.

The music industry in particular has a strong interest in protecting its proprietary works from unauthorized copying and distribution, especially over the Internet or through other computer-based copying and distribution using music ripping software or other techniques. A number of attempts have been made by the music industry to provide music CDs that can be reliably played in consumer CD players but that somehow are resistant to digital audio extraction by a personal computer. Although there has been some success in this area, anything less than 100 percent playability by the wide array of consumer CD players that are already in use is extremely undesirable. When a consumer purchases a new CD he or she expects it to play in his or her equipment, and there is a great amount of anger and frustration if it does not. The record industry is extremely reluctant to take the rest of this happening to its end consumers who appropriately purchase its music offerings. In addition, the reliability of protection against unauthorized copying and other digital extraction provided by the techniques that have been so far developed by the industry has been haphazard, being highly dependent upon specific hardware characteristics, firmware versions and countermeasures that have been employed by various forms of software. Another disadvantage of such technology is that it prevents a consumer who has legitimately purchased a compact disc from playing music files from the compact disc using his or her computer. Many consumers who purchase music on compact discs expect to be able to play them on their computers, or at least to extract the music to their hard drives using software that contains a digital rights management protocol, such as Windows Media Player.®

The introduction of technology that is marketed by SunnComm Technologies Inc. under the trademark MediaMax represented a significant advance in the field of copy protection for digital works. In this technology, music files are provided in a compressed format, specifically a format that is subject to a digital rights management protocol, on a second Yellow Book data session of the CD. Software which is automatically loaded on to the personal computer from the CD when the CD is loaded into the CD/DVD drive of the computer will direct the computer user to the alternative content instead of to the CD-DA files that are contained in the first, Red Book session of the CD. Although the technology has met with commercial success and has proven to be effective it does have the disadvantage that it consumes space on the CD that could otherwise be used for the Red Book content. In addition, in order for the system to operate effectively it presumes that the appropriate player software has been installed on to the personal computer for playing the compressed file format, which might not always be the case.

A need exists for an improved system and method for protecting digital content that does not adversely affect playability, that reliably prevents unauthorized duplication of digital content and that furthermore provides consumers an opportunity to play music that they have purchased on their personal computers. A need further exists for such a system and method that does not consume excessive space on the digital media or carrier on which the digital content is contained, and that does not require pre-installation of specific player software on to the personal computer.

### SUMMARY OF THE INVENTION

Accordingly, it is an object of the invention to provide an improved system and method for protecting digital content that does not adversely affect playability, that reliably prevents unauthorized duplication of digital content and that furthermore provides consumers an opportunity to play music that they have purchased on their personal computers. It is further an object of the invention to provide such a system and method that does not consume excessive space on the digital media or carrier on which the digital content is contained, and that does not require pre-installation of specific player software on to the personal computer.

In order to achieve the above and other objects of the invention, a method of operating a personal computer according to a first aspect of the invention includes steps of determining whether a digital recordation of content that is readable by a hardware device in the personal computer is protected; and responsive to a determination that the digital recordation of content is protected, selectively limiting which software programs are permitted to access digital information from the digital recordation of content.

According to a second aspect of the invention, a copy protected digital source of content includes a storage media; a digital work that is encoded in a first digital format on the storage media; administrative means on the storage media for installing an administrative program onto a personal computer that is constructed and arranged to selectively control access to data from the storage media; and conversion means on the storage media for installing a conversion program onto the personal computer that will be permitted by the administrative program to convert the digital work to a second digital format for storage on the personal computer.

A method of operating a personal computer according to a third aspect of the invention includes steps of determining that a digital recordation of content has been inserted into a hardware device in the personal computer; and selectively limiting which software programs are permitted to access digital information from the digital recordation of content.

A method of protecting a digital work according to a fourth aspect of the invention includes steps of restricting access to a digital work in a personal computer to at least one authorized computer program; providing digital rights management licensing conditions to the authorized computer program that have been specified by a content provider of the digital work; and accessing the digital work with the authorized computer program subject to the specified licensing conditions.

A method of protecting a digital work that is stored on a portable digital storage media according to a fifth aspect of the invention includes steps of connecting the portable digital storage media to a personal computer; determining with the personal computer that the digital work is copy protected; denying access to the digital work by unauthorized computer programs; obtaining licensing condition information pertaining to the digital work; and using an authorized computer program on the personal computer to convert the digital work to a digital format that is subject to a digital rights management protocol in which said licensing condition information is specified.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagrammatical depiction of a digital recordation of content that is constructed according to a preferred embodiment of the invention;

FIG. 2 is a diagrammatical depiction of a personal computer having a CD/DVD-ROM drive installed therein;

FIG. 3 is a schematic depiction of first and second sessions contained on a CD that is constructed according to the preferred embodiment of the invention;

FIG. 4 is a schematic diagram depicting operation of the administrative program that is constructed according to a preferred embodiment of the invention;

FIGS. 5A and 5B represent a logical flowchart depicting a process that is performed according to the preferred embodiment of the invention; and

FIG. 6 is a logical flowchart depicting a second part of a process that is depicted in FIGS. 5A and 5B.

### DETAILED DESCRIPTION OF THE PREFERRED EMBODIMENT(S)

Referring now to the drawings, wherein like reference numerals designate corresponding structure throughout the views, and referring in particular to FIG. 1, a digital recordation of content on a storage media 10 that is constructed according to a preferred embodiment of the invention is preferably embodied as a compact disc or CD 12 which, according to industry standard specifications, includes a center hole 14 and a continuous track 16 that is arranged in a helical pattern around the center hole 14. Information on a compact disc is recorded in a plurality of optically readable marks in a format that is specified by one or more industry standards. For example, data information is specified by what is commonly referred to as the Yellow Book standard, while audio information is provided a format that is specified by the Red Book standard. The information is typically pressed into the material from which the compact discs made, forming embossed pits and lands between the pits, each of which represents a single unit of binary or digital information.

Although in the preferred embodiment of the invention the digital recordation of content 10 is embodied as a compact disc, it should be understood that a digital recordation of content could alternatively take the form of a digital versatile disc or DVD, optical or magnetic digital tape, a hard drive, or any of a plurality of possible types of portable digital media, such as memory sticks, high-capacity magnetic storage cartridges or wireless remote storage options.

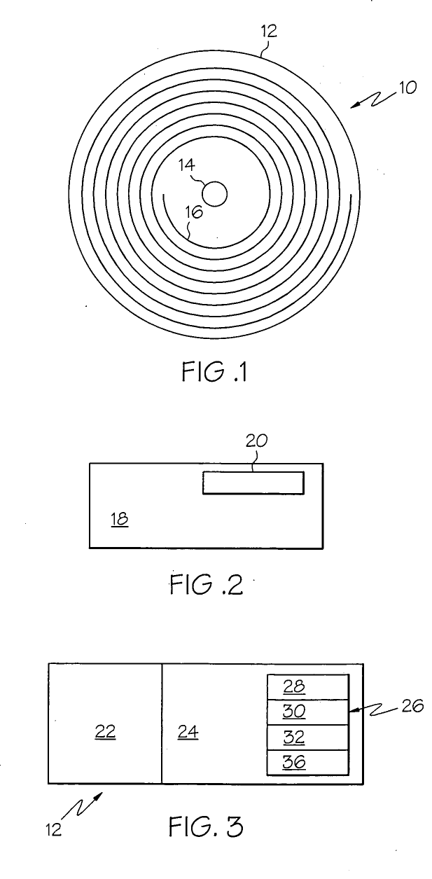

Shown schematically in FIG. 2 is a personal computer 18 that has installed therein a hardware device for reading the storage media 10. In the preferred embodiment, the hardware device is a CD/DVD-ROM drive 20 that is capable of reading information from the compact disc 12. Alternatively, the hardware device could be a DVD ROM drive, a magnetic or optical tape reader or any other type of hardware that is appropriate for reading the storage media 10 that may be selected within the broad scope of the invention.

Referring now to FIG. 3, it will be seen that the CD 12 contains a first session 22 that is preferably formatted according to the Red Book standard for digital audio. In other words, first session 22 contains a number of audio files that are in the CD-DA format. As is further shown in FIG. 3, CD 12 contains a second session 24 that is preferably formatted as a data session, according to the Yellow Book standard format. Second session 24 preferably includes an executable self extracting utility file 26 that is constructed and arranged to preferably install at least four software programs on to the personal computer 18 when the CD 12 is inserted into the CD/DVD-ROM drive 20. In a Windows™ operating environment, the file that instructs the personal computer to automatically execute the executable self extracting utility file 26 is typically an .inf file format, which will also be provided in the second session 24. The four programs that will be installed on to the personal computer by the self extracting utility file 26 include an administrative program 28, a conversion program 30 and a secure player program 32, and a controlled copy program 36, the details of which will be described in greater detail below. These four programs perform separate distinct functions but could alternatively be combined in a single program performing all functions within the scope of the invention.

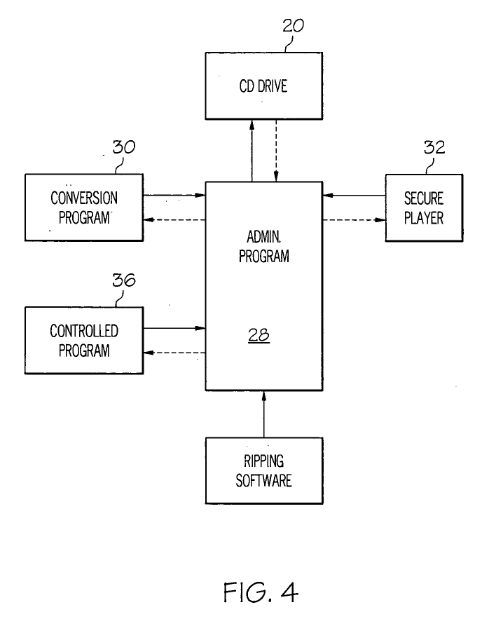

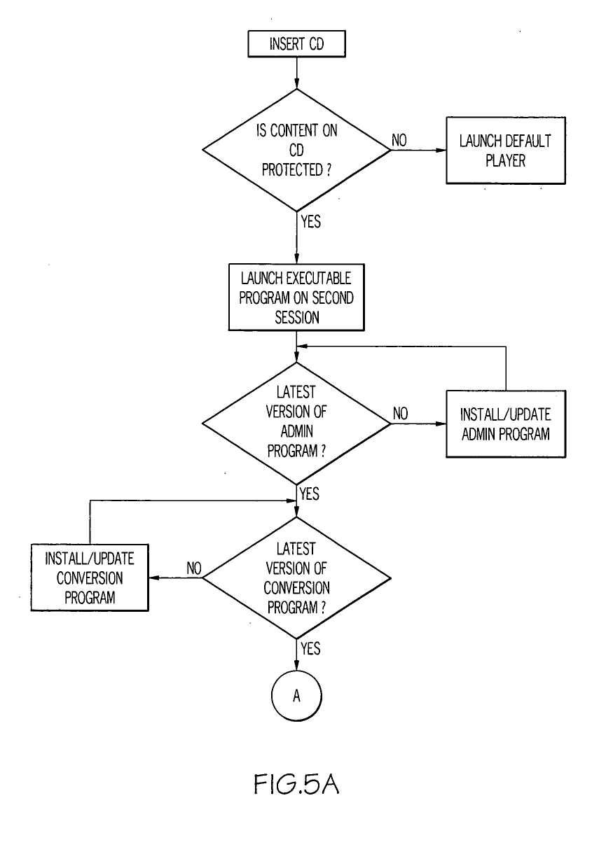

As is shown schematically in FIG. 4, the administrative program 28 once installed functions as a gatekeeper to information originating from the CD/DVD-ROM drive 20 including, of course, the protected content that is contained on the first session 22 of the CD 12. The administrative program 28 is in two-way communication with the CD/DVD-ROM drive 20 and is further configured to securely communicate with the conversion program 30, the secure player program 32 and the controlled copy program 36 that is constructed and arranged to permit a consumer to make a limited number of backup copies of the digital recordation of content. The details of the controlled copy program 36 are disclosed in PCT patent application PCT/US02/15972, the disclosure of which is hereby incorporated as if set forth fully herein.

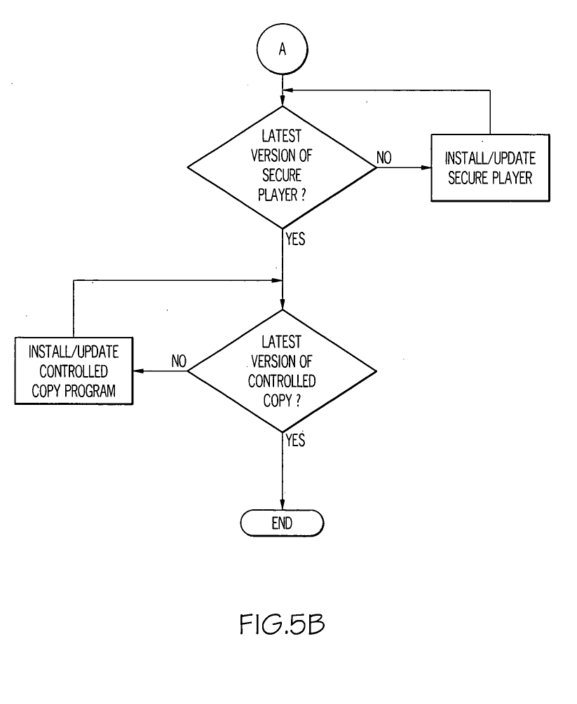

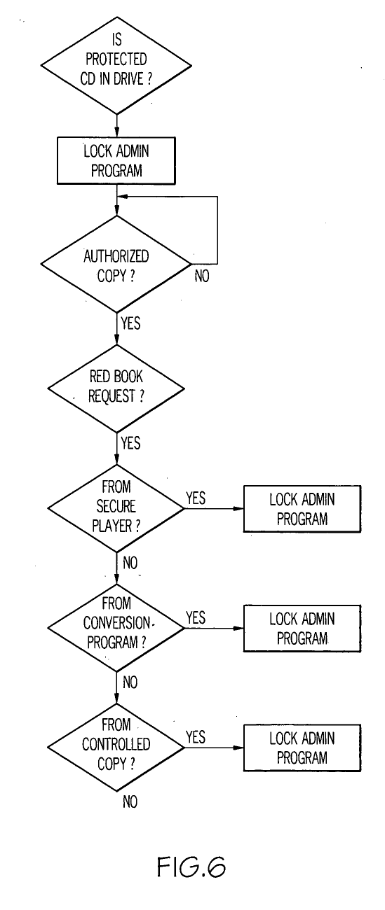

FIGS. 5A and 5B depict a process according to the preferred embodiment of the invention that is initiated with the insertion of a CD 12 into the CD/DVD-ROM drive 20 of the personal computer 18. If no data session is detected on the CD 12, the Windows operating system will launch the default software that is installed on the personal computer 18 for playing Red Book audio files. If, however, a data session according to the Yellow Book standard and configured according to the invention is detected on the CD 12 the Windows operating system will be instructed by the .inf file that is located on the second session 24 to launch the self-extracting utility program 26. Program 26 will first check to determine whether the latest version of the administrative program 28 is installed on the personal computer 18. If it is not, program 26 will install the latest version of the administrative program 28. After completion of this sequence, program 26 will determine whether the latest version of the conversion program 30 is installed on the personal computer 18 and will attend to installation of this program if it is not. Program 26 will then determine whether the latest version of the secure player program 32 is installed on the personal computer 18, and will insure as to its installation if it is not. Program 26 will then determine whether the latest version of the controlled copy program 36 is installed on the personal computer 18, and will insure as to its installation if it is not. In the preferred embodiment of the invention, all of the necessary software for installing the administrative program 28, the conversion program 30, the secure player program 32 and the controlled copy program 36 is contained within the self extracting utility program 26 that is provided on the second session 24. Alternatively, however, if it is desired to make the program 26 more compact it would be equally within the scope of the invention to configure the utility program 26 to administer the downloading of the necessary software code from the Internet or to activate code that is already preinstalled on to the personal computer 18. It is further anticipated that as the invention gains market penetration one or more of the component programs such as the administrative program 28, the conversion program 30, the secure player program 32 and/or the controlled copy program 36 will be preinstalled on to the personal computer 18 as part of the OEM package, possible as part of the operating system.

After installation of the administrative program 28, the administrative program 28 will monitor the CD/DVD-ROM drive 20 and any additional CD/DVD-ROM drives to determine whether a digital recordation of content is present that contains content that is protected according to the invention. This may be done on a session by session basis or on an audio track by audio track basis, according to possible alternative embodiments of the invention. Preferably, the digital recordation of content is encoded to indicate whether or not content recorded thereon is protected. This coding may be embedded within the content files themselves (the CD-DA files in the case of an audio CD) or located elsewhere on the digital media such as in the table of contents, the lead-in area or the lead-out area. Alternatively, the presence of protected content on the compact disc 12 could be indicated to the personal computer 18 and specifically the administrative program 28 by any one of a number of different techniques, such as by searching for a particular file in the second data session, reviewing the size of a particular file, performing a check sum on a particular file or numbers of files, or looking for data within one or more particular files or within a predetermined sector or sectors. Specifically, a digital code could be added to the table of contents, to one of the P-W subchannels, to a reserved area on the Yellow Book session, or in the lead-out.

If the administrative program 28 determines that there is no protected content, the default player software may be launched by the operating system of the personal computer 18, and the content contained within the audio tracks of the compact disc may be played normally without interference from the administrative program 28. In the embodiment of the invention where each audio track is checked for protected content, the default audio software may be permitted to access data from nonprotected tracks without interference from the administrative program 28 while data from protected tracks will be prevented from reaching the default audio software intact, as will be described in greater detail below.

Once protected content is detected on the digital recordation of content, the administrative program 28 will monitor the data stream between the hardware device in which the digital recordation of content is installed, which in the preferred embodiment is the CD/DVD-ROM drive 20, and any software application running on the personal computer 18 that may request information from the protected content. In the preferred embodiment, the administrative program 28 monitors the low-level SCSI command set instructions that are given to the CD/DVD-ROM drive 20. When a software application 34 such as those that are typically used to “rip” or create compressed digital audio files such as MP3s attempt to access the digital information that is contained on a protected audio track, the administrative program 28 will detect this request on the SCSI command level and, instead of returning the requested information will either not respond or return incorrect information to the software application. This incorrect information may be accurate information from a sector other than the sector from which the information was requested, completely random information, or the requested information upon which additional information has been superimposed. For example, the requested information could be returned with additional superimposed encoding that will have the effect of providing periodic unpleasant noises such as beeps or a prerecorded voice indicating that protected content is being requested. Preferably, the information that is returned by the administrative program 28 to the software application is returned in such a way that the software application will not be able to detect that anything other than the requested information has been provided. As a result, it will be difficult to employ effective countermeasures within the software application.

FIG. 6 is a logical flow diagram depicting a process that is performed according to the preferred embodiment of the invention upon loading of a CD 12 into a CD/DVD-ROM drive 20 of a personal computer 18 that has been configured according to the preferred embodiment of the invention. As described above, the administrative program 28 will continuously monitor data from the CD/DVD-ROM drive 22 in order to determine whether the CD 12 is protected according to the invention. Upon determination that there is protected content on the CD 12 the administrative program 28 will be cycled to what will be referred to as a locked condition, meaning that no unauthorized software program on the personal computer 18 will be permitted to access uncorrupted data from the CD/DVD-ROM drive 20. Certain authorized software programs will be permitted to access uncorrupted data from the CD/DVD-ROM drive 20, including the conversion program 30, the secure player program 32 and the controlled copy program 36. These authorized programs will be provided with an authorization code that will be recognized by the administrative program 28 as an instruction to grant access to the data from the CD/DVD-ROM drive 20. All data communication between the administrative program 28 and any authorized program is preferably encrypted so as to prevent the interception and utilization of this data by other software on the personal computer 18, such as software that could be developed by hackers for the express purpose of pirating the digital recordation of content that is contained on the CD 12. In the locked condition, the administrative program 28 will preferably deny access to software such as MP3 ripping software 34 or it will alternatively return corrupted information to such software that will frustrate efforts at unauthorized duplication of the digital work that is contained on the CD 12.

The administrative program 28 will then determine whether the CD 12 is an authorized copy such as an original stamped version of a compact disc or an unauthorized copy. This determination may be made in a number of different ways that are well known in this area of technology. The CD authentication mechanism is preferably either based on certain steps executed during the CD manufacturing process or on changes that are introduced by the supervisory program during the unauthorized copy process. For example, specific errors may be introduced on the disc during the CD replication process that can be detected by CDROM/DVD drives but not reproduced with regular CDROM/DVD burners. Alternatively, changes may be introduced in the sub-channels, to the CD-DA files, in the file structure on the second session, or by changing the content of certain files on the second session. If the CD 12 is determined to be an unauthorized copy the administrative program 28 will remain locked to all requests that are made to access to the protected content, i.e., the CD-DA files in the case of a Red Book standard audio CD.

As FIG. 6 shows, when the administrative program 28 detects a request that is made by a software program running on the personal computer 18 for access to the Red Book standard material (the CD-DA files) on the first session 22 of the CD 12 a determination is made whether the request is originating from the secure player software 32 and whether the authorization code is present. If the request is determined as originating from the secure player software 32 and the authorization code is determined to be present, the administrative program 28 will be unlocked for this request, but will remain locked in the event that simultaneous requests are made from unauthorized programs. The secure player program 32 will thus be permitted to play CD-quality audio track directly from the Red Book standard session without the need for conversion into a compressed format. This will provide the consumer with higher-quality audio than would be possible using compressed file formats.

If the request is not from the secure player program 32, the administrative program will determine whether or not the request is originating from the conversion program 30. If the request is determined to be originating from the conversion program 30 and if the necessary authorization code is present the administrative program 28 will be unlocked for this request, but will remain locked in the event that simultaneous requests is made from an unauthorized program or programs.

If the request is not from the conversion program 30, the administrative program will determine whether or not the request is originating from the controlled copy software 36. If the requested is determined to be originating from the controlled copy software 36 and if the necessary authorization code is present, the administrative program 28 will permit access by the controlled copy software 36 to the Red Book standard data.

In the preferred embodiment of the invention, the conversion program 30 and the secure player program 32 preferably share a user interface that will permit the computer user to either play music directly from the CD 12 using the secure player program 32 or to copy the music to the hard drive of the personal computer 18 using the conversion program 30. The conversion program 30 converts, on-the-fly, the Red Book audio files into a compressed file format that is governed by a digital rights management protocol that will control the terms on which the Red Book audio content may be used and will prevent effective sharing of these files between different personal computers. For example, the Microsoft® DRM protocol that is used according to the preferred embodiment of the invention permits a content provider to specify the (1) maximum number of allowed burns to CD; (2) the maximum number of allowed transfers to SDMI compliant portable devices; (3) the expiration of user rights by date; (4) the expiration of user rights by number of days; and (5) the expiration of user rights by number of plays. One important aspect of the invention is that by denying access to the protected content except through authorized programs, it enables the content provider to ensure that any use of the protected content by the consumer's personal computer will be governed by the content provider's own preferred DRM license conditions rather than those chosen by the consumer or provided by default by third-party software on the personal computer. For example, one recording artist or record company may desire to limit the number of permitted CD burns to a single backup copy of the CD, while another may choose more liberal terms. Broadly speaking, the invention permits a content provider to impose the selected license conditions upon the user of a personal computer as a direct consequence or result of the digital media bearing the protected content being inserted into the appropriate interface hardware of the personal computer. In the preferred embodiment, the specified DRM license conditions are encoded on the digital media together with the protected content and these license conditions are read, interpreted and enforced by those programs that are authorized to unlocked the administrative program 28. Alternatively, however, the specified DRM license conditions may be obtained from an alternative source subsequent to the insertion of the digital media bearing the protected content into the personal computer. For example, software and the personal computer might be configured to identify the specific audio CD that has been inserted into the CD/DVD-ROM Drive and download the applicable DRM license conditions from an Internet server.

Alternatively, it may be preferable to configure the conversion program 32 to enable it to specifically identify the audio tracks on the Red Book session and to download the alternative DRM file format to the personal computer 18 from the Internet rather than performing the processor intensive task of conversion. It is anticipated that this alternative embodiment of the invention will have greater utility in the future as the penetration of broadband Internet access to consumer households continues to increase.

In one embodiment of the invention, the administrative program 28 will maintain a log detailing relative information relating to requests that are received for access to information from the Red Book session from all software programs, authorized and unauthorized. This information may periodically be uploaded to a central server via the Internet for analysis. For example, it may be possible to detect the proliferation of hacker software that succeeds in counterfeiting the authorization code necessary to unlock the administrative program 28 and to take appropriate countermeasures in subsequent updates.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A method of operating a personal computer, comprising:
(a) determining whether a digital recordation of content that is readable by a hardware device in the personal computer is protected; and
(b) responsive to a determination that the digital recordation of content is protected, selectively limiting which software programs are permitted to access digital information from the digital recordation of content.

2. A method of operating a personal computer according to claim 1, further comprising a step of implementing an administrative program to monitor a data stream between the hardware device and a top-level software program.

3. A method of operating a personal computer according to claim 1, further comprising a step of implementing an administrative program to selectively control access to data from the hardware device.

4. A method of operating a personal computer according to claim 1, wherein the digital recordation of content is provided in a first digital format, and wherein said step of selectively limiting which top-level software programs are permitted to access digital information from the digital recordation of content is performed by accessing said digital information with a conversion program and using the conversion program to convert the digital information into a second digital format.

5. A method of operating a personal computer according to claim 4, wherein the second digital format is subject to a digital rights management protocol.

6. A method of operating a personal computer according to claim 4, wherein the second digital format is more compressed than the first digital format.

7. A method of operating a personal computer according to claim 4, further comprising the step of providing the digital recordation of content in the first digital format, the administrative program and the conversion program to the personal computer on an optical disc that is readable by the hardware device.

8. A method of operating a personal computer according to claim 7, wherein the digital recordation of content in the first digital format is provided on a first session of the optical disc and wherein the conversion program and the administrative program are provided on a second session of the optical disc.

9. A method of operating a personal computer according to claim 3, further comprising a step of instructing the administrative program to selectively lock or unlock access to data from the hardware device.

10. A method of operating a personal computer according to claim 9, further comprising instructing the administrative program to unlock access to data from the hardware device by using an authorized player program that is enabled to securely play the digital recordation of content.

11. A copy protected digital source of content, comprising:
a storage media;
a digital work that is encoded in a first digital format on said storage media;
administrative means on said storage media for installing an administrative program onto a personal computer that is constructed and arranged to selectively control access to data from said storage media; and
conversion means on said storage media for installing a conversion program onto the personal computer that will be permitted by the administrative program to convert the digital work to a second digital format for storage on the personal computer.

12. A copy protected digital source of content according to claim 11, wherein said storage media comprises an optical disc.

13. A copy protected digital source of content according to claim 12, wherein said optical disc comprises a compact disc, said digital work comprising an audio work that is encoded in standard Redbook format on a first session of the compact disc, said administrative means and said conversion means being provided on a second session of the compact disc.

14. A copy protected digital source of content according to claim 11, further comprising secure player means also provided on said storage media for installing a player program on to the personal computer that will enable a user to play the digital work directly from the first digital format.

15. A method of operating a personal computer, comprising:
(a) determining that a digital recordation of content has been inserted into a hardware device in the personal computer; and
(b) selectively limiting which software programs are permitted to access digital information from the digital recordation of content.

16. A method of operating a personal computer according to claim 15, further comprising a step of implementing an administrative program to monitor a data stream between the hardware device and a top-level software program.

17. A method of operating a personal computer according to claim 15, further comprising a step of implementing an administrative program to selectively control access to data from the hardware device.

18. A method of operating a personal computer according to claim 15, wherein said step of selectively limiting which software programs are permitted to access digital information from the digital recordation of content comprises granting access to secure player software for playing the digital information, and wherein transmission of said digital information to said secure player software is encrypted.

19. A method of operating a personal computer according to claim 15, further comprising a step of determining specific digital rights management license conditions that have been specified by a content provider of the digital information, and wherein said step of selectively limiting which software programs are permitted to access the digital information is performed by denying access to the digital information to software programs that will not enforce said license conditions.

20. A method of operating a personal computer according to claim 19, wherein said step of determining specific digital rights management license conditions is performed by extracting information relating to those conditions from the digital recordation of content.

21. A method of protecting a digital work; comprising:
restricting access to a digital work in a personal computer to at least one authorized computer program;
providing digital rights management licensing conditions to the authorized computer program that have been specified by a content provider of the digital work; and
accessing the digital work with the authorized computer program subject to the specified licensing conditions.

22. A method of protecting a digital work according to claim 21, wherein said step of restricting access to said digital work comprises a step of implementing an administrative program to selectively control access to data from a hardware device of the personal computer.

23. A method of protecting a digital work according to claim 21, wherein said digital work is provided on a digital recordation of content that is readable by a hardware device of the personal computer.

24. A method of protecting a digital work according to claim 23, wherein said step of providing digital rights management licensing conditions to the authorized computer program comprises extracting information relating to said conditions from said digital recordation of content.

25. A method of protecting a digital work according to claim 21, wherein said authorized computer program comprises a conversion program for converting the digital work to a file format that is governed by a digital rights management protocol, and wherein said conversion program is configured to ensure that said licensing conditions are specified in said file format.

26. A method of protecting a digital work according to claim 21, wherein said authorized computer program comprises a secure player program for playing the digital work, and wherein the digital work is transmitted to said secure player program in an encrypted communication.

27. A method of protecting a digital work according to claim 21, wherein said authorized computer program comprises a controlled copy program that is configured to permit at least one copy of the digital work to be made on a portable digital media subject to said licensing conditions.

28. A method of protecting a digital work that is stored on a portable digital storage media, comprising:
connecting said portable digital storage media to a personal computer;
determining with the personal computer that the digital work is copy protected;
denying access to the digital work by unauthorized computer programs;
obtaining licensing condition information pertaining to the digital work; and
using an authorized computer program on the personal computer to convert the digital work to a digital format that is subject to a digital rights management protocol in which said licensing condition information is specified.

29. A method of protecting a digital work according to claim 28, wherein said step of obtaining licensing condition information comprises extracting said licensing condition information from said portable digital storage media.
